(19) United States
(12) Patent Application Publication
(10) Pub. No.: US 2007/0182765 A1
(43) Pub. Date: Aug. 9, 2007

(54) Display device with sensor

(75) Inventor: Akihiro Okano, Tokyo (JP)

Correspondence Address: SUGHRUE-265550, 2100 PENNSYLVANIA AVE. NW, WASHINGTON, DC, 20037-3213, US

(73) Assignee: PIONEER CORPORATION, Tokyo (JP)

(21) Appl. No.: 11/652,594

(22) Filed: Jan. 12, 2007

(30) Foreign Application Priority Data
Jan. 12, 2006 (JP) 2006-004694

(51) Int. Cl. G09G 5/02

(52) U.S. Cl. 345/695

(57) ABSTRACT

A display device includes a plurality of polygonal display elements each including: a display unit that displays an image; and a sensor disposed at a peripheral edge of the display unit.

### CROSS-REFERENCE TO RELATED APPLICATIONS

This application is based on and claims the benefit of priority from the prior Japanese Patent Application No.2006-004694, filed on Jan. 12, 2006; the entire contents of which are incorporated herein by reference.

### BACKGROUND

1. Technical Field

The present invention relates to a display device with a sensor.

2. Related Art

In the prior art, there has been practiced a touch panel display, in which a touch sensor is arranged as selection unit for the screen display is arranged on the screen. In the touch panel display, portions displaying buttons or letters are widely utilized because they can easily select and instruct when directly touched. The displays of various structures and configurations have been proposed, as disclosed in JP-A-2005-264845.

### SUMMARY

In the display device of recent years, the screen progresses to a larger size. When the touch panel or the touch panel function of the prior art is to be mounted on the large display, there arises a problem that the manufacture cost remarkably rises. This is because the touch panel display of the prior art has to be manufactured with the touch panel or its function unit each time in conformity to the size of the display.

Moreover, the touch panel display of the prior art has a problem that all the detections may become impossible when one or more detection configurations fail.

An object of the invention is exemplified by a display device with a sensor, which can constitute a screen of various sizes and surface shapes. Another object of the invention is exemplified by a display device with a sensor, which is not deteriorated in the detection precision even against a failure of a partial detection configuration and which is high in the maintenance.

According to an aspect of the invention, there is provided a display device including a plurality of polygonal display elements each including: a display unit that displays an image; and a sensor disposed at a peripheral edge of the display unit.

### BRIEF DESCRIPTION OF THE DRAWINGS

FIG. 1 is a schematic view showing the configuration of a display device with a sensor in an embodiment of the invention;

FIG. 2 is a schematic view showing the exterior of the display element constituting the display device with the sensor in the embodiment of the invention;

FIG. 3 is a diagram schematically showing a sectional structure of the display element;

FIG. 4 is a schematic diagram showing a display element having an external shape of hexagon, and its connection example;

FIG. 5 is a schematic diagram showing a display element having an external shape of octagon, and its connection example;

FIG. 6 is a diagram conceptionally showing the display device with the sensor, which is formed by arranging the hexagonal display elements;

FIG. 7 is a diagram (for the square) for explaining a sensor contact detecting method for the display device with the sensor in the embodiment of the invention;

FIG. 8 is a diagram (for the hexagon) for explaining a sensor contact detecting method for the display device with the sensor in the embodiment of the invention;

FIG. 9 is a diagram schematically showing a display device with a sensor, which is constituted by arraying the display elements in a curved plane shape; and

FIG. 10 is a diagram schematically showing a spherical type display device with a sensor, in which the display elements are arranged in a spherical face.

### DESCRIPTION OF THE EMBODIMENTS

The display device with the sensor according to the invention has its best mode of embodiment in that the display screen of the device entirety is constituted by arranging a plurality of display elements having a polygonal external shape, in which a display unit for displaying an image is disposed at a central portion and which is provided with a sensor (or a touch sensor) at the peripheral edge portion of the display unit.

With this configuration, it is possible to provide a display device with a sensor, which can constitute a screen of various sizes and surface shapes, which is not deteriorated in the detection precision even against a failure of a partial detection configuration and which is high in the maintenance.

Moreover, it is preferred that the display elements are square. In case the display screen is rectangular in its entirety, therefore, the display elements can be closely laid without any clearance. Especially in the case of a square or rectangle, the display elements can be easily manufactured, but may also have other shapes such as parallelograms or rhombuses.

Alternatively, it is preferred that the display elements are hexagonal. As compared with the rectangular case, therefore, the kinds of the direction of the sensor arranged at the peripheral edge are increased (to three kinds of longitudinal and two oblique directions) to enhance the sensing precision.

Alternatively, it is preferred that the display elements are octagonal. As a result, the kinds of the direction of the sensor arranged at the peripheral edge are further increased (to four kinds of longitudinal, transverse and two oblique directions) to enhance the sensing precision better. In the octagonal case, moreover, clearances (in which no image is displayed) are necessarily formed. These clearances may be clogged with other members, but can also be intentionally made hollow to provide such effects as to improve ventilations or that the background of the display can be seen therethrough (or can be fitted with transparent members such as glass plates).

Specific one embodiment of the mode of embodiment of the invention is described in detail in the following with reference to the accompanying drawings.

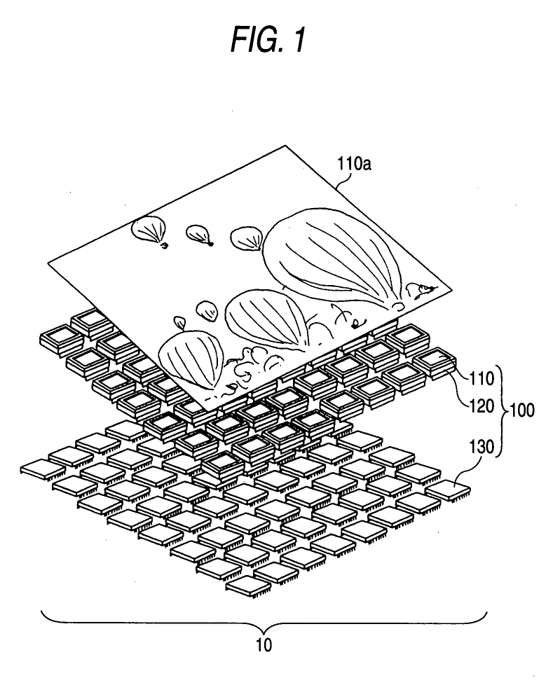

FIG. 1 is a schematic view conceptionally showing the configuration of a display device with a sensor in the embodiment of the invention. As shown in FIG. 1, the display device 10 with the sensor is constituted by arranging a plurality of display elements 100 on a plane. With this configuration, the display device 10 with the sensor can display an image 110a (which shows one example of the image displayed by the entirety of the display device 10 with the sensor) in its entirety, for example, by combining images displayed in the individual display elements 100.

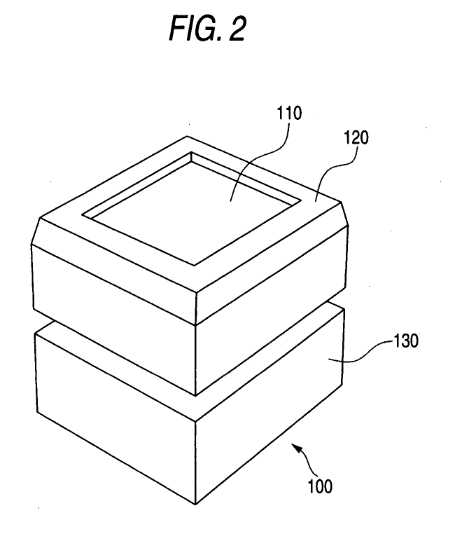

FIG. 2 is a schematic view showing the exterior of the display element 100 constituting the display device 10 with the sensor, as shown in FIG. 1. The display element 100 is provided with a display unit 110, a sensor 120 and a receptor 130. These elements can be connected to constitute a display device of arbitrary shape and size. One sensor 120 may cover the four sides in accordance with a necessary resolution, or independent sensors 120 may be disposed, if necessary, one or more for each side.

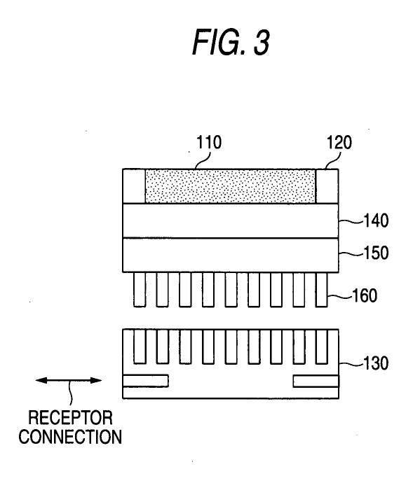

FIG. 3 is a diagram schematically showing a sectional structure of the display element 100. The display unit 110 is arranged on the upper face of the element, and the sensor 120 is arranged at the peripheral edge of the display unit 110. This display unit 110 is a liquid crystal display or the like, and has its lower layer formed by laminating a back light 140, a control module 150, a power source and control signal lines 160, and the receptor 130 sequentially in the recited order. The receptor 130 has a connecting portion, through which the receptors 130 are connected to each other thereby to form the display device 10 with the sensor. Specifically, the display unit 110 is made of a display element such as the liquid crystal for displaying in response to an image signal inputted from the outside. The sensor 120 detects a contact such as a finger depression.

The back light 140 is a back light in the display unit 110. The control module 150 transmits either the image signal inputted from the outside, to the display unit 110, or a detection signal from the sensor 120 to the outside, thereby to perform the controls on the whole actions of the display element 100. The power source and control signal lines 160 are arranged in an interface portion for connecting the control module 150 and the outside, and are connected to the outside through the receptor 130.

The receptor 130 is a structure for placing a block containing the display unit 110 and the sensor 120, and is-worked into such a shape as to connect the display elements to each other. The receptor 130 is so wired as can effect the electric connection with the adjoining display element.

Here, the display element constituting the display device with the sensor according to the embodiment of the invention is not limited to a square shape, as exemplified in the embodiment thus far described, but can be applied to all polygonal shapes.

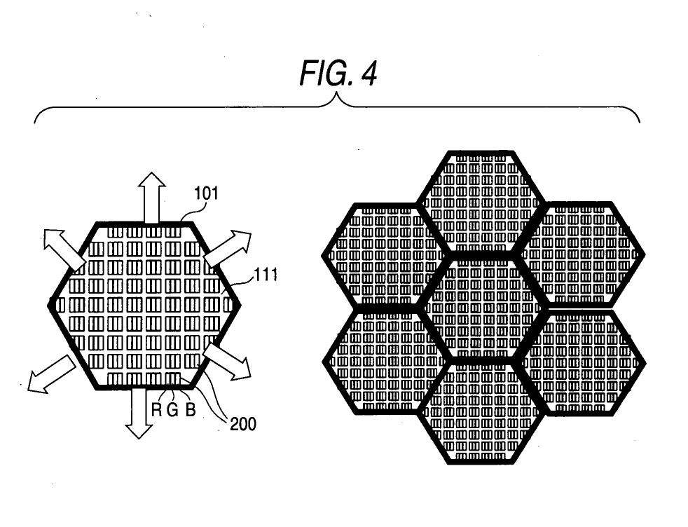

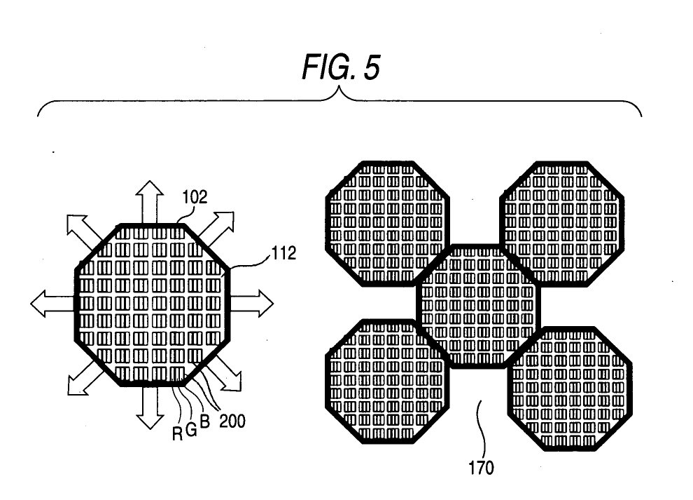

FIG. 4 is an enlarged schematic diagram of an essential portion showing an example (i.e., a display element 101) having an external shape of hexagon, and its connection example. On the other hand, FIG. 5 is an enlarged schematic diagram of an essential portion showing an example (i.e., a display element 102) having an external shape of octagon.

In FIG. 4 or FIG. 5, the display units 111 and 112 of the individual display elements 101 and 102 are constituted, for example, by laying a plurality of RGB pixels 200, so that the color image can be displayed.

Here, the display unit 110 of the aforementioned square display element 100 may also be constituted, although its detail has been omitted, by laying the RGB pixels.

As compared with the case of the square, as shown in FIG. 4 or FIG. 5, the direction kinds of the sensors 120 arranged at the peripheral edges are increased to enhance the sensing precision. Although the square case has two kinds of longitudinal and transverse directions, more specifically, the hexagon case has three kinds of longitudinal and two oblique directions, and the octagon case has four kinds of longitudinal, transverse and two oblique directions. As a result, the detection precision is high, in case the display is scanned thereon by a finger or the like (or traced by a finger or the like). In the case of the octagonal display element, however, clearances 170 are left when the display elements are arranged in connection.

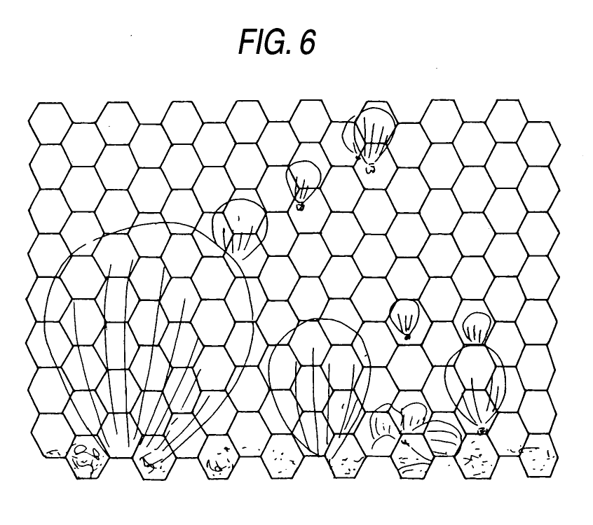

FIG. 6 is a diagram conceptionally showing one example, in which an image is displayed in the display device with the sensor, as formed by arranging the hexagonal display elements.

Here are described the actions of the display device with the sensor thus constituted. The image displaying actions of the display device with the sensor, which is formed by connecting numerous display elements, may use the well-known display control method in the conventional display. Hence, the detailed description is omitted.

Here is described a sensor contact detecting method in the display device with the sensor according to the embodiment of the invention.

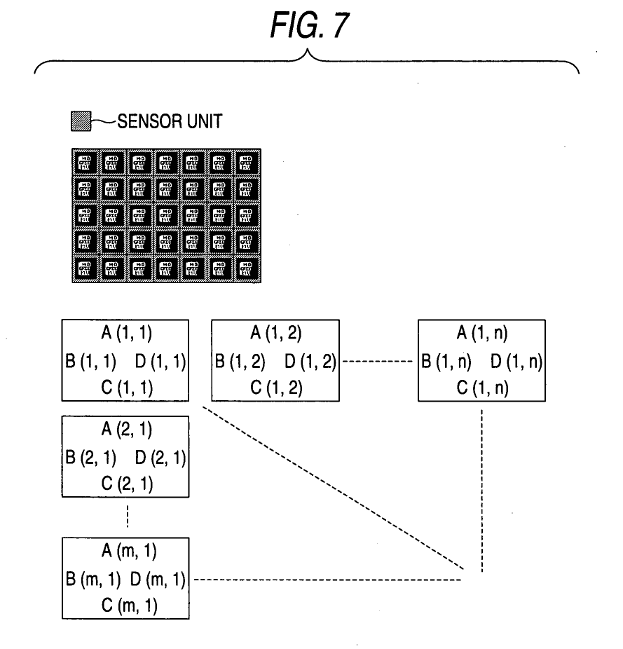

FIG. 7 is a diagram for explaining a sensor contact detecting method for the display device with the sensor in the embodiment of the invention. FIG. 7 shows the display device with the sensor, in which square display elements are arranged. If the individual four sides of elements arranged in m lines and n columns are designated by A(m, n), B(m, n), C(m, n) and D(m, n), the display elements constituting the display device with the sensor in the embodiment of the invention individually have the small module sizes so that they can be simplified by D (1, 1) & B(1, 2), C(1, 1) & A(2, 1) or by the facial single detecting discrimination. Even in case a system failure is caused by the contact detection method of the prior art for detecting the screen position, therefore, the entire system failure can be avoided by the detection with a not-failed cell (or element).

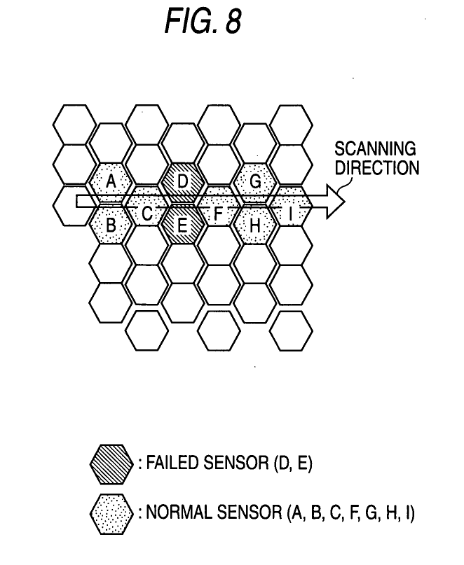

Moreover, a similar contact detection can also be done even in the display device with the sensor, in which the hexagonal display elements are arranged, as shown in FIG. 8. In case the finger is moved rightward to scan the display, for example, all the horizontal (or vertical) lines are not detection-failed even if the elements D and E are failed, because the sensor is independent. Thus, the failure can be remedied merely by replacing the display element at the corresponding portions. As a result, the maintenance can be easier than that of the touch panel of the prior art.

The display elements 100, 101 and 102 of the individual shapes thus far described are preferred to have sizes of about a finger tip, e.g., a diameter of about 1 cm. In the scanning case with the finger, therefore, a resolution as fine as about the finger thickness can be obtained as the scan position.

In the display device with the sensor according to the embodiment of the invention, however, the size of the display elements should not be limited to the above-specified one, but the number and arrangement of the display elements and the sensors can be suitably set.

Here is described a specific application example of the display device with the sensor according to the embodiment of the invention.

The display device with the sensor according to the embodiment of the invention is constituted by connecting the small display elements so that it can enjoy high degrees of freedom in the shape and size and in the surface shape of the screen.

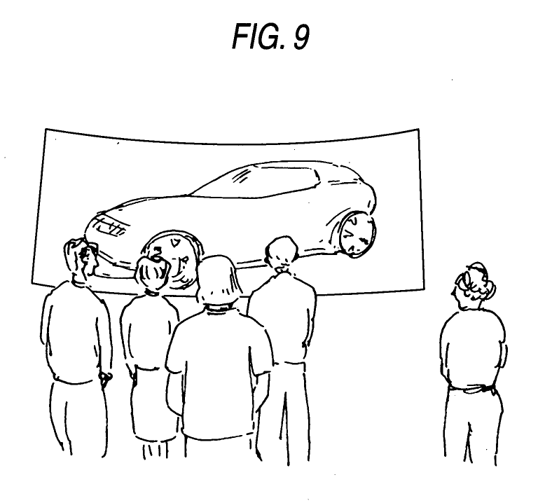

FIG. 9 is a diagram schematically showing a display device with a sensor, which is constituted by arraying the display elements in a curved plane shape. Depending upon the display control method, it can be expected to relax such a distortion of a corner portion as will unavoidably occur in the flat display device of the prior art.

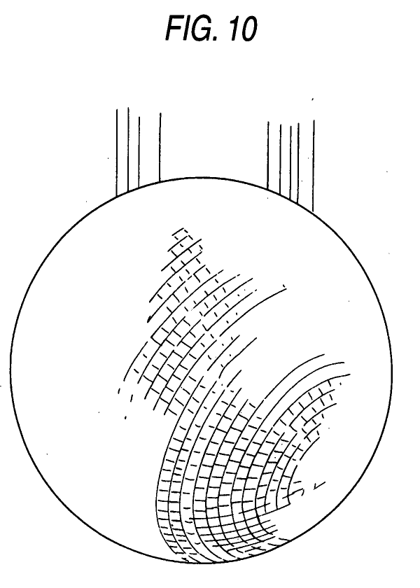

On the other hand, FIG. 10 is a diagram schematically showing a spherical type display device with a sensor, in which the display elements are arranged in a spherical face. This display device allows the display to be visually recognized in all directions.

If the display device with the sensor according to the embodiment of the invention is thus applied, it is possible to constitute screens of all sizes and surface shapes. Especially even in case the screen is enlarged, the detection resolution of the sensor can be prevented from being reduced, and the abrupt rise in the cost according to the enlargement of the screen can be suppressed. Moreover, the display device is excellent in maintenance.

Here in the foregoing embodiment, the display unit 110 is a liquid crystal display, but should not be limited thereto. The display unit 110 may also employ a display using the organic EL (Electroluminescence), the inorganic EL (Electroluminescence), the LED (Light Emitting Diode) or the PDP (Plasma Display Panel). On the other hand, the sensor 120 may also be not only a piezoelectric sensor or a switch for detecting a physical contact but also a non-contact sensor such as a light detecting sensor.

As has been detailed hereinbefore, the display device 10 with the sensor according to the embodiment constitutes the display screen by arranging a plurality of polygonal display elements 100 having the sensors 120 at the peripheral edges.

As a result, the screens of all sizes and surface shapes can be constituted at lower prices than that of the prior art, if the display elements of a predetermined shape are freely connected two- or three-dimensionally. Even if the display elements are failed, moreover, the detection can be made by the adjoining elements, and the failure can be eliminated merely by replacing that failed element. As a result, it is possible to provide the display device with the sensor, which is not deteriorated in its detection precision by the partial failure and which is excellent in the maintainability.

What is claimed is:

1. A display device comprising
a plurality of polygonal display elements each including: a display unit that displays an image; and a sensor disposed at a peripheral edge of the display unit.

2. The display device according to claim 1, wherein the display elements are square.

3. The display device according to claim 1, wherein the display elements are hexagonal.

4. The display device according to claim 1, wherein the display elements are octagonal.
